(19) United States
(12) Patent Application Publication
(10) Pub. No.: US 2016/0336777 A1
(43) Pub. Date: Nov. 17, 2016

(54) FIXED CHARGING UNIT HAVING RETRACTABLE CHARGING CABLES

(71) Applicant: Patrick Barnidge, St. Louis, MO (US)

(72) Inventor: Patrick Barnidge, St. Louis, MO (US)

(21) Appl. No.: 14/950,753

(22) Filed: Nov. 24, 2015

Related U.S. Application Data
(60) Provisional application No. 62/161,861, filed on May 14, 2015.

(51) Int. Cl. H02J 7/00

(52) U.S. Cl. CPC H02J 7/0042

(57) ABSTRACT

A charging device for charging personal electrical devices is provided. The charging device includes a housing, a first charging cable configured to electrically couple to an electrical device, an electrical receptacle, and a power connector configured to receive electrical energy from an electrical outlet. The first charging cable and the electrical outlet are electrically coupled to the power connector. The charging device also includes a fastener configured to securely fasten the housing of the charging device to the electrical outlet.

### CROSS REFERENCE TO RELATED APPLICATIONS

This application claims the benefit of U.S. Provisional Application No. 62/161,861 filed May 14, 2015, which is hereby incorporated by reference in its entirety.

### BACKGROUND

This disclosure relates generally to battery chargers and, more particularly, to a fixed charging unit having retractable charging cables.

Many portable electronic devices, such as smart phones and tablets, require repeated charging to maintain operation. Generally, this charging is done through the use of charging cables, or in some cases very specific chargers. The charging cables connect the portable electronic device to power sources, for example electrical outlets or larger electronic devices, such as desktop or laptop computers. To provide utility, these charging cables are portable. However, due to their portability and size, chargers often get “borrowed,” lost, or stolen because it is easy for one to remove them from their electrical outlets. While not in use, charging cables clutter the floors, desks, and countertops in the ambient environment. Charging cables are typically manufactured for a single device, for example micro-USB, LIGHTNING (APPLE COMPUTER, INC., Cupertino, Calif.), or other types. Some existing fixed charging units require that the device being charged be positioned atop the charging unit, which is precarious and increases the possibility that the device being charged will be damaged by, for example, falling to the floor.

### BRIEF DESCRIPTION

In one embodiment, a charging device for charging electrical devices is provided. The charging device includes a housing, a first charging cable configured to electrically couple to an electrical device, an electrical receptacle, and a power connector configured to receive electrical energy from an electrical outlet. The first charging cable and the electrical outlet are electrically coupled to the power connector. The charging device also includes a fastener configured to securely fasten the housing of the charging device to the electrical outlet.

In another embodiment, a method of fabricating a charging device for charging electrical devices is provided. The method includes providing a first charging cable wound around a charging cable spool, enclosing the first charging cable and the charging cable spool in a housing, positioning an electrical receptacle on a first exterior side of the housing, and positioning a power connector to a second exterior side of the housing. The power connector is configured to electrically couple to an electrical outlet. The method also includes electrically coupling the electrical receptacle and the first charging cable to the power connector, and providing a fastener to fasten the housing to the electrical outlet.

In yet another embodiment, a method of charging an electrical device is provided. The method includes extending a charging cable from a housing. When retracted the charging cable is stored in the housing. The method also includes electrically coupling the charging device into an electronic device, transferring electrical energy from an electrical outlet, through the charging cable to the electrical device, receiving a press of a button from a user, and retracting the charging cable into the housing.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a first example configuration of a charging unit that connects over an existing electrical outlet;

FIG. 2 illustrates a second example configuration of a charging unit that connects over an existing electrical outlet;

FIG. 3 illustrates a third example configuration of a charging unit that connects over an existing electrical outlet;

FIG. 4 illustrates an example configuration of how a charging unit connects to an existing electrical outlet;

FIG. 5 provides a view of charging unit having a spool assembly incorporated therein for deploying and retracting a charging cable;

FIG. 6 illustrates a detailed view of the spooling unit of FIG. 5, dissociated from the charging unit; and

FIG. 7 illustrates a view of a charging unit, wherein the charging cable is shown deployed and attached to a mobile device for charging.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

The following detailed description illustrates embodiments of the disclosure by way of example and not by way of limitation. The description clearly enables one skilled in the art to make and use the disclosure, and describes several embodiments, adaptations, variations, alternatives, and uses of the disclosure, including what is presently believed to be the best mode of carrying out the disclosure. The disclosure is described as applied to an example embodiment, namely, apparatus and systems for providing a fixed charging unit with retractable cables. More specifically, the disclosure describes a fixed charging unit that integrates with existing electrical outlets and provides retractable charging cables to charge portable electronic devices.

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that may permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and interchanged; such ranges are identified and include all the sub-ranges contained therein unless context or language indicates otherwise.

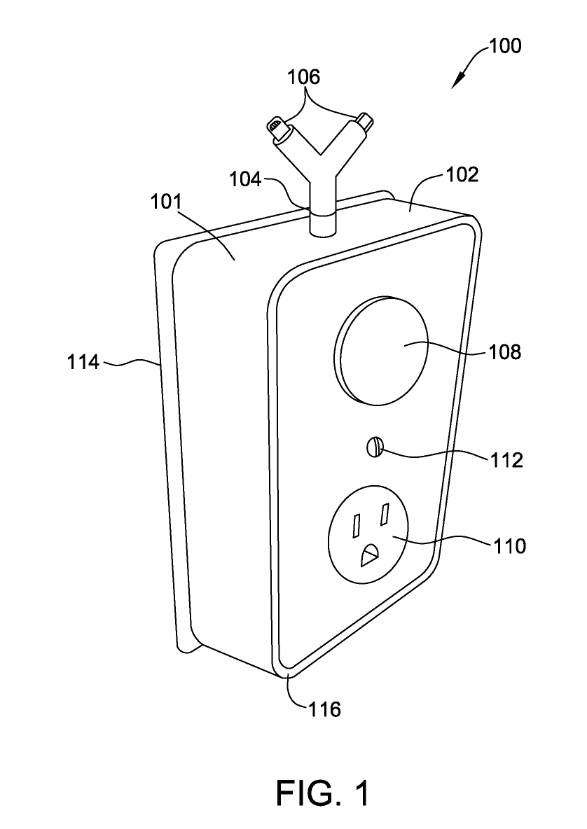

FIG. 1 illustrates a first example configuration 100 of a charging unit 101 that connects over an existing electrical outlet. In the example embodiment, charging unit 101 connects over an existing electrical outlet 114. Charging unit 101 includes a housing 102 to enclose the necessary components. Charging unit 101 also includes a retractable charging cable 104 which includes one or more charging tips 106. Charging unit 101 further includes a button 108, an electrical receptacle 110, a fastener 112, and a light 116.

Charging unit 101 also includes a power connector (not shown) that electrically couples charging unit 101 to the existing electrical outlet. In some embodiments, the power connector is a two prong connector. In other embodiments, the power connector is a three prong connector that connects to a three prong electrical outlet. In these embodiments, the power connector could connect to either receptacle of the existing electrical outlet. In still other embodiments, the power connector is two sets of prongs to connect to two receptacles of an existing electrical outlet. In still further embodiments, the power connector connects to all of receptacles of an existing electrical outlet, such as in the case of a four receptacle outlet. One skilled in the art would realize that power connector also could be configured to connect to electrical outlets in different configurations all over the world. The power connector connects electrical outlet 114 with charging cable 104 and electrical receptacle 110 to provide electrical energy to devices connected to charging cable 104 or electrical receptacle 110. In the example embodiment, charging unit 101 also includes a power regulator (not shown) to control the flow of electrical energy from existing electrical outlet 114 and prevent overloading any devices connected to charging unit 101. In some embodiments, the power regulator is an AC to DC convertor. In some further embodiments, the power regulator is located in charging cable 104. In still further embodiments, the power regulator is located at the end of charging cable 104 closest to one or more charging tips 106.

In the example embodiment, charging cable 104 includes two charging tips 106. In an embodiment, these two charging tips 106 are in a rabbit-ear configuration. In other embodiments, the two charging tips are in a T configuration. Each charging tip 106 provides a mount for a different type of charging tip for the charging cable 104. In some embodiments, charging tips are permanently mounted to charging cable 104. In other embodiments, charging tips 106 are swappable, so that the user may change the devices that they connect to. In some embodiments, charging cable 104 may have different charging tips 106 built into the charger. In these embodiments, a charging cable 104 may include a micro-USB tip and a LIGHTNING (APPLE COMPUTER, INC., Cupertino, Calif.) tip.

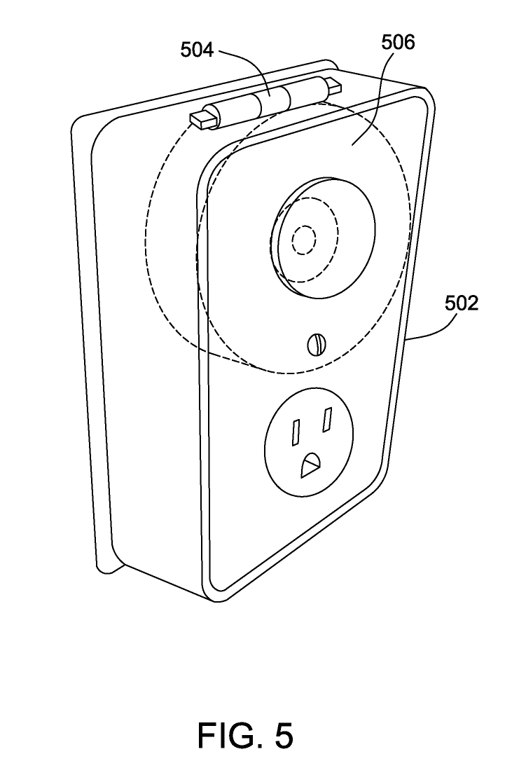

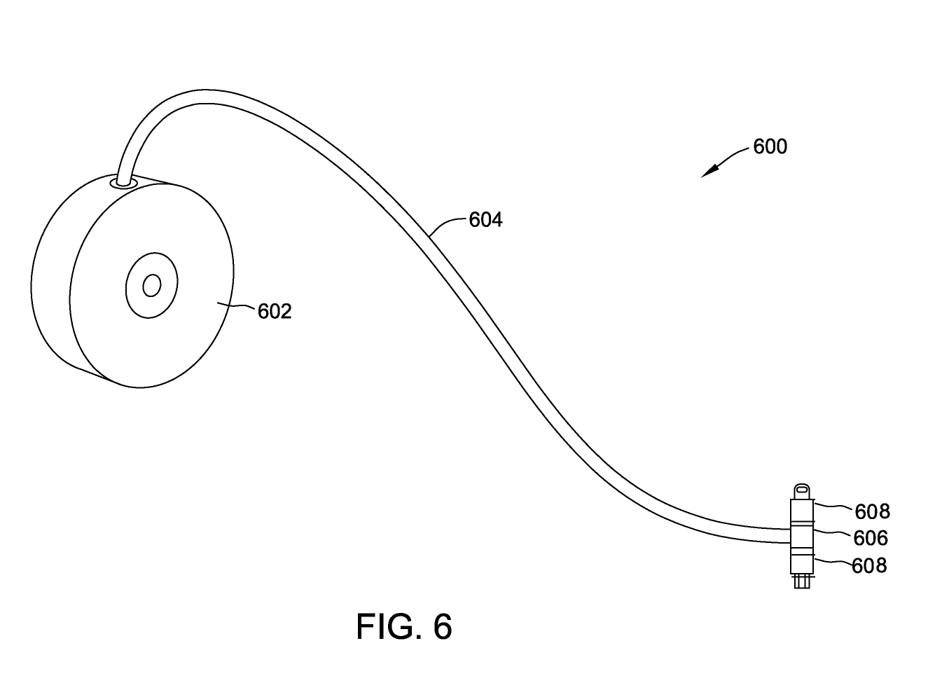

Charging cable 104 is stored on a spool concealed within housing 102 when not in use, as shown in FIGS. 5 and 6. During use, charging cable 104 may be retractably unreeled from the spool so that charging tip 106 at the distal end of charging cable 104 may be plugged into a port situated on an external surface of an electronic device to be charged. The user pressing button 108 initiates the retraction of retractable charging cable 104. In some embodiments, charging cable 104 only retracts while button 108 is being pressed. In other embodiments, after button 108 is pressed, charging cable 104 retracts until fully retracted, whether or not button 108 is continually pressed. In the example embodiment, button 108 is situated on housing 102.

Charging unit 101 further includes one or more receptacle 110 for receiving plugs of the type normally used in existing electrical outlet 114. In the example embodiment, receptacles 110 are situated on the face of housing 102 opposite of the power connector.

Fastener 112 affixes charging unit 101 to existing electrical outlet 114. In the example embodiment, fastener 112 is longer center set screw that travels through the charging unit and into an opening threaded to receive the set screw, thereby securing the unit in place and making it difficult to remove without the proper tools. Charging unit 101 is sited for use by mating the power connector with corresponding slots on an electrical socket, such as electrical outlet 114. Charging unit 101 may then be secured to the electrical receptacle by placing fastener 112, such as a set screw, within a screw hole on the face of housing 102 of charging unit 101 and threading the screw into a threaded opening on the face of the electrical outlet 114. In some embodiments, housing 102 includes a faceplate (not shown) that conceals fastener 112. In other embodiments, the fastener may be two set screws, one at the top of the outlet and one at the bottom. Or the fastener may be any other fastening mechanism that allows charging unit 101 to be secured to electrical outlet 114.

In an embodiment, charging unit 101 includes light 116 to indicate the charge status of any electrical device connected to charging unit 101. For example, light 116 is colored red while the connected electrical device is charging and changes to green then the connected electrical device is fully charged. In other embodiments, the brightness of light 116 may change based on the amount of charge in connected electrical device. In still further embodiments, light 116 emits a pattern of colors that changes based on the amount of charge in the connected electrical device. In some embodiments, light 116 and button 108 combined having the dual functions of illuminating the face of the charging unit and, when pressed, triggering retraction of the corresponding charging cable.

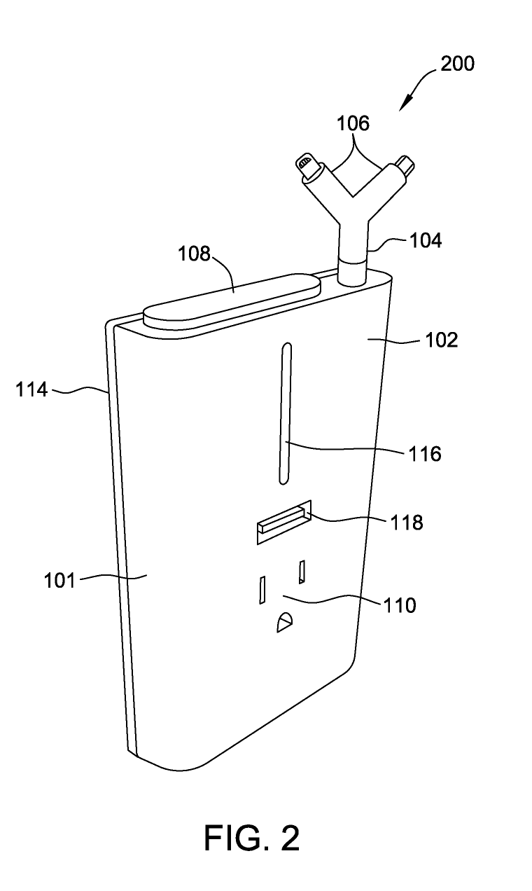

FIG. 2 illustrates a second example configuration 200 of a charging unit 101 that connects over an existing electrical outlet 114. In configuration 200, charging unit 101 includes a USB (Universal Serial Bus) port 118. USB port 118 may be situated on any face of housing 102 so that a user may plug a USB cable into USB port 118.

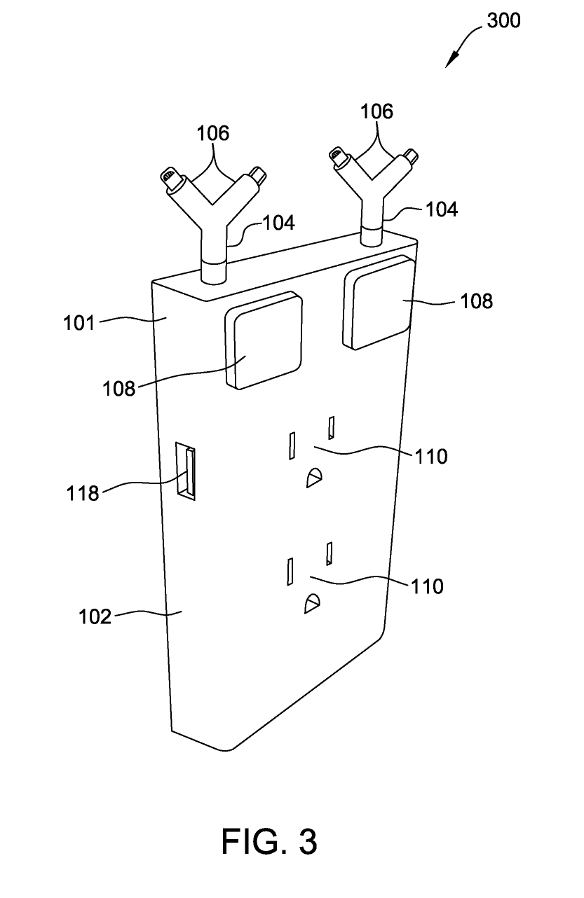

FIG. 3 illustrates a third example configuration 300 of a charging unit 101 that connects over an existing electrical outlet 114. In configuration 300, charging unit 101 includes two retractable charging cables 104 along with two electrical receptacles 110. While FIG. 3 shows embodiments each having two charging cables 104, embodiments may include more than two charging cables 104. It will be noted that each charging cable 104 is provided with a corresponding button 108 for retracting the corresponding charging cable 104.

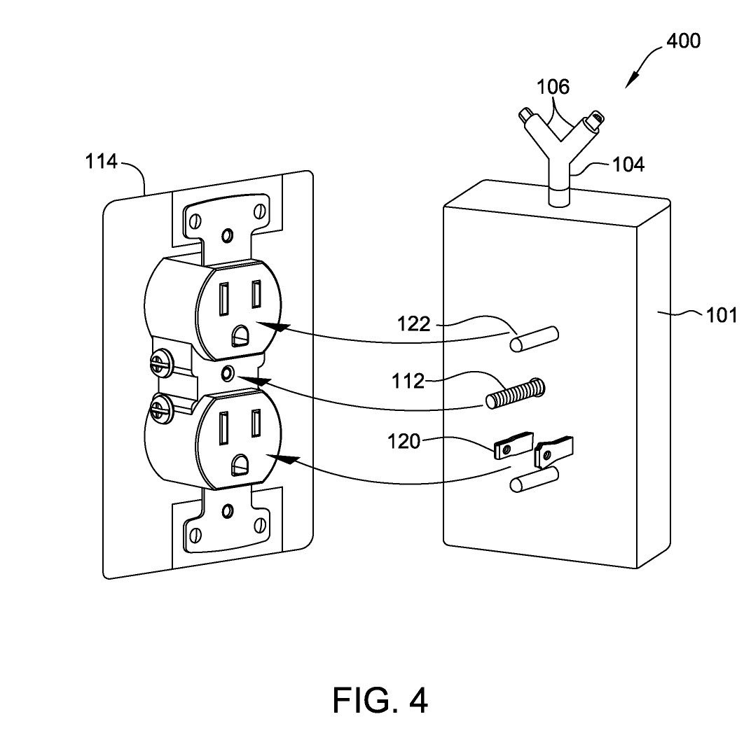

FIG. 4 illustrates an example configuration 400 of how charging unit 101 connects to existing electrical outlet 114. Charging unit 101 includes one or more power connectors 120. In FIG. 4, charging unit 101 includes power connector 120 which is a three-prong electrical plug and a secondary ground connector 122. Both power connector 120 and secondary ground connector 122 guide charging unit 101 onto existing electrical outlet 114. Fastener 112 further connects charging unit 101 to existing electrical outlet 114. In some embodiments, secondary ground connector 122 is replaced by a second power connector 120. Power connector 120 is designed based on the locality where charging unit 101 is to be used. Potential power connector configurations include, but are not limited to, NEMA 1-15 unpolarised, NEMA 1-15 polarised, JIS C 8303 (Class II), NEMA 5-15, NEMA 5-20, JIS C 8303 (Class I), CEE 7/16 (Europlug), CEE 7/17 plug, GOST 7396 C 1, BS 4573, BS 546, IS 1293 (India), SABS 164-3 (South Africa), CEE 7/6 plug, CEE 7/4 plug (Schuko), BS 1363, IS 401, IS 411, MS 589, SS 145, SI 32, TIS 166-2549, AS/NZS 3112, CPCS-CCC, IRAM 2073, Swiss SEV 1011:2009/A1:2012, Type 12 plug and Typ 13e socket, Danish 107-2-D1, CEI 23-50 (formerly CEI 23-16), BS 546, IS 1293 (India), SABS 164-1 (South Africa), Brazilian NBR 14136 (2 pin), Brazilian NBR 14136 (3 pin), South Africa SABS 164-2 (2 pin), and South Africa SABS 164-2 (3 pin). Additionally, in some embodiments, power connector 120 is configured for residential outlets, in other embodiments, power connector 120 is configured for commercial outlets.

In some embodiments, charging unit 101 may be installed and wired directly into an electrical box, which securely keeps charging unit 101 in place, not removable by anyone lacking the tools and knowledge to undo the electrical connection with the electrical box. As shown in FIGS. 1-4, charging unit 101 mounted into the electrical box juts out to allow more space for components and for a larger cable spool inside the charging unit.

FIG. 5 provides a view of charging unit 101 having a spool assembly 506 incorporated with housing 502 for deploying and retracting a charging cable 504. In the example embodiment, spool 506 and charging cable 504 are structurally connected. In the example embodiment, spool 506 is anchored to an inside surface of the housing 502. In some embodiments, spool 506 may be energized by means of externally-supplied electrical power from electrical outlet 114 (shown in FIG. 1).

FIG. 6 illustrates a detailed view 600 of the spool assembly 506 of FIG. 5, dissociated from charging unit 101 (shown in FIG. 1). View 600 illustrates an unwound charging cable 604 which is connected to a spool assembly 602 on one end. Unwound charging cable also includes a charging end 606 which includes two charging tips 608 on distal ends of the charging end 606.

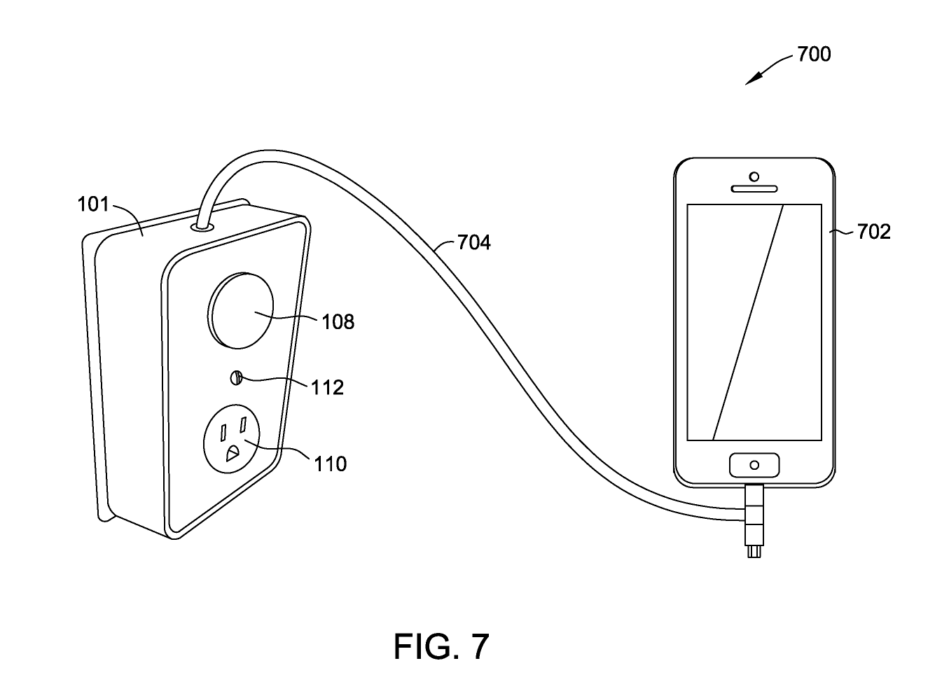

FIG. 7 illustrates a view 700 of a charging unit 101, wherein charging cable 704 is shown deployed and attached to a mobile device 702 for charging.

When charging cable 704 is pulled out and plugged into a device such as a tablet computer or smart phone, charging cable 704 supplies power for charging the device. While charging unit 101 is plugged into the device being charged, light 116 (shown in FIG. 1) may illuminate to show the show the user that a charge is being delivered. When charging is complete, charging cable 704 may be retracted by pushing button 108 (shown in FIG. 1). The electrical device may be, but is not limited to a personal digital assistant (PDA), a cellular phone, a smartphone, a tablet, a phablet, a personal gaming device, a camera, an audio recording device, a video recording device, an audio playback device, a video playback device, a watch, a wearable device, speakers, or any other portable device requiring charging.

Embodiments may be manufactured from conventional materials commonly available for manufacture of electrical devices. The use of conventional materials provides the benefit of reducing cost and increasing the ease of manufacture for the charging unit.

Although specific features of various embodiments may be shown in some drawings and not in others, this is for convenience only. In accordance with the principles of the systems and methods described herein, any feature of a drawing may be referenced or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A charging device for charging electrical devices, said charging device comprising:
a housing;
a first charging cable configured to electrically couple to an electrical device, wherein said first charging cable is configured to retract into said housing, wherein said first charging cable comprises a charging end that comprises two charging plugs positioned on opposite sides of said charging end, wherein said two charging plugs are configured to simultaneously couple to a first electrical device and a second electrical device while both the first and second electrical device are positioned horizontally on a horizontal surface;
an electrical receptacle; and
a power connector configured to receive electrical energy from an electrical outlet, wherein said first charging cable and said electrical outlet are electrically coupled to said power connector.

2. The charging device of claim 1 further comprising a power regulator configured to control the transfer of electrical energy between said power connector and said first charging cable.

3. The charging device of claim 1, wherein said housing further comprises a button, wherein when a user presses said button, said charging cable retracts into said housing.

4. The charging device of claim 1, wherein said housing encloses a charging cable spool and said charging cable is wound around said charging cable spool when said charging cable is retracted.

5. The charging device of claim 4, wherein said charging cable is configured to extend from said housing when pulled by the user.

6. The charging device of claim 1, further comprising one or more Universal Serial Bus (USB) outlets electrically coupled to said power connector.

7. (canceled)

8. The charging device of claim 1, wherein said charging plugs each include a removable charging tip.

9. The charging device of claim 1, wherein said power connector includes one or more sets of prongs for connecting to the electrical outlet.

10. The charging device of claim 1, wherein said fastener is a screw that connects to a screw hole in the electrical outlet.

11. The charging device of claim 1, further comprising a second charging cable electrically coupled to said power connector.

12. The charging device of claim 1, further comprising a second electrical receptacle connected to said power connector.

13. The charging device of claim 1, wherein the electrical device is portable.

14. The charging device of claim 1, wherein the electrical device is one of a personal digital assistant (PDA), a cellular phone, a smartphone, a tablet, a phablet, a personal gaming device, a camera, an audio recording device, a video recording device, an audio playback device, a video playback device, a watch, a wearable device, and one or more speakers.

15. The charging device of claim 1, further comprising a light configured to change color based on a charging status of a connected electrical device.

16. A method of fabricating a charging device for charging electrical devices, the method comprising:
providing a first charging cable wound around a charging cable spool, wherein the first charging cable comprises a charging end that comprises two charging plugs positioned on opposite sides of the charging end;
enclosing said first charging cable and said charging cable spool in a housing, wherein said first charging cable is configured to retract into said housing;
positioning an electrical receptacle on a first exterior side of said housing;
positioning a power connector to a second exterior side of said housing, wherein said power connector is configured to electrically coupled to an electrical outlet;
electrically coupling said electrical receptacle and said first charging cable to said power connector; and
providing a fastener to fasten said housing to the electrical outlet.

17. A method of charging an electrical device comprising:
extending a charging cable from a housing, wherein when retracted the charging cable is stored in the housing, wherein the first charging cable comprises a charging end that comprises two charging plugs positioned on opposite sides of the charging end;
electrically coupling the charging device into an electronic device;
transferring electrical energy from an electrical outlet, through the charging cable to the electrical device;
receiving a press of a button from a user; and
retracting the charging cable into the housing.

18. The charging device of claim 1, further comprising a second charging cable configured to electrically couple to an electrical device, wherein said second charging cable is configured to retract into said housing.

19. The charging device of claim 1, further comprising a fastener configured to securely fasten said housing of said charging device to the electrical outlet.
